(19) United States
(12) Patent Application Publication
(10) Pub. No.: US 2023/0373127 A1
(43) Pub. Date: Nov. 23, 2023

(54) Foamed Biogranulate Grains

(71) Applicant: Hannes Bichsel, Burgdorf (CH)

(72) Inventor: Hannes Bichsel, Burgdorf (CH)

(21) Appl. No.: 18/031,419

(22) PCT Filed: Oct. 14, 2021
(86) PCT No.: PCT/EP2021/078521

§ 371 Date: Apr. 12, 2023

(30) Foreign Application Priority Data
Oct. 14, 2020 (EP) 20201883.4

(51) Int. Cl. B27N 3/00; B27N 7/00

(52) U.S. Cl. CPC B27N 3/005; B27N 7/00

(57) ABSTRACT

A semi-finished product for the production of mouldings is disclosed. The product includes foamed biogranulate grains having a coating. The coating includes an adhesive whereby the biogranulate grains are bondable together in a moulded body. The coating further includes a pesticide. A method of manufacturing a semi-finished product is also disclosed. The foamed biogranulate grains are coated with an adhesive and a pesticide. In a method for producing the moulded body, the semi-finished product is introduced into a press mould and then joined together under the action of heat to form the moulded body.

### TECHNICAL FIELD

The invention relates to a semi-finished product for the production of moulded bodies comprising foamed biogranulate grains, wherein the biogranulate grains have a coating, wherein the coating comprises an adhesive, with which the biogranulate grains can be joined together in a moulded body. The invention further relates to a process for producing the semi-finished product and a moulded body produced from the semi-finished product, as well as a process for producing the moulded body from the semi-finished product.

### BACKGROUND ART

It has long been known to use foamed biogranules as a material in various fields.

Foamed biogranulate grains are understood to be all foamable grains. A typical representative of foamed biogranulate grains is puffed maize (a representative of which, which is typically not used as a material, is so-called popcorn). Rice, wheat, rye, barley, oats, millet, quinoa, spelt, etc. can also be used. The foamed biogranulate grains are produced using a hydrothermal expansion process. The grain, in particular the maize, may have been comminuted in advance for this purpose. This achieves a better mechanical bond among the puffed grains, especially in the production of moulded bodies, as these are not round.

Foamed biogranulate grains, in particular puffed maize, are used in loose form as packaging material. Furthermore, it is known to press and/or glue puffed maize into mouldings in order to create dimensionally stable components in various applications.

From EP 2 961 580 B1 (Univ. Göttingen Georg August), for example, it is known to use popcorn in wood and/or composite materials, in particular chipboard and fibreboard, insulating boards, material boards and composite materials. For this purpose, materials made of shredded lignocellulosic material or popcorn are glued with a synthetic or near-natural binder and pressed under temperature and pressure to form composite materials.

The disadvantage of the known processes is that the foamed biogranulate grains can only be kept for a short time after coating. The production of the semi-finished product (foamed biogranulate grains coated with adhesive) is therefore typically carried out on site where the mouldings are produced. This prevents decentralised and thus cost-effective production of the semi-finished product.

### SUMMARY OF THE INVENTION

It is the object of the invention to create a semi-finished product for the production of moulded bodies pertaining to the technical field initially mentioned, that can be produced particularly efficiently and which also remains storable and transportable and, in particular, free-flowing, while maintaining a constant quality.

The solution of the invention is specified by the features of claim 1. According to the invention, the coating comprises a pesticide.

The coating, which includes a pesticide, can make the foamed biogranulate grains particularly durable. Depending on the field of application of the semi-finished products (building insulation, packaging, tableware, automotive parts, furniture, etc.), different pesticides may be provided, for example fungicides, herbicides, bactericides, insecticides, molluscicides, ovicides, rodenticides, etc. It is also conceivable to use combinations of the above pesticides, for example rodenticides together with ovicides. In the application in facade construction in buildings, for example, rodenticides and fungicides may be provided, while in the application in furniture insecticides and fungicides are provided. Particularly preferably, the pesticide is biodegradable. In variants, this property can be dispensed with.

Foamed biogranulate grains are understood to be, for example, puffed (or foamed) cereals and pulses, in particular puffed maize, wheat, rice, peas, etc. The puffing of the biogranulate grains is carried out according to the so-called Bichsel process, which is described in detail in the patent specification EP 0 975 238 B1. The puffing device comprises a heating device for preheating the biogranulate grains and a puffing reactor for puffing the biogranulate grains. The heating device has a jet fluidised bed without a flow bottom, in which a batch of the material to be heated can be subjected to a heat-carrying, gaseous medium in a preheating process which is timed to the puffing process and takes place in batches. Preferably, this is a hydrothermal puffing process.

This process produces puffed biogranulate grains which have particularly resilient properties. These properties are of particular advantage in the use of the puffed biogranulate grains in the production of moulded bodies. Such moulded bodies preferably retain the resilient properties of the biogranulate grains, making such moulded bodies particularly resilient, durable and stable.

In principle, puffed particles can also be obtained with hot air or by extrusion. However, these have the disadvantage of being brittle in texture (vitrified starch) due to the low water content. Shaped bodies with complex shapes and mechanical demands cannot be produced with them.

The texture of the biogranulate grains to be used according to the invention is thus preferably soft, spongy and springy. When compressed by a factor of 1.5, the particles preferably spring back to their original dimensions within a maximum of minutes. Hydrothermally puffed biogranulate grains can be compressed to half to one third of their dimensions. When the compression force is removed, the particles spring back to almost their original size. This effect can be controlled by the moisture of the hydrothermally puffed particles. The natural moisture content of 4-9% is sufficient for most cereals to achieve the springy property. If there is a lack of moisture, the broken-down starch becomes brittle and the spring effect is lost.

In principle, the adhesive can be of any type, in particular mixtures of several adhesives or only a single adhesive can be provided. Preferably, the adhesive is a biodegradable adhesive. In variants, this property can be dispensed with.

The adhesive is preferably such that the foamed biogranulate grains coated with it are free-flowing. This allows the semi-finished product to be introduced particularly efficiently into a mould, which in turn allows particularly homogeneous mouldings to be produced. The adhesive can, for example, comprise a thermoplastic polymer. However, the adhesive can be in the form of a reactive adhesive. Other variants are known to the skilled person.

The adhesive is preferably applied as a melt to the foamed biogranulate grain. In variants, a solution can also be used, whereby the solvent is evaporated or otherwise removed after application.

Preferably, the adhesive and the pesticide are biodegradable, so that the semi-finished product as a whole is biodegradable or environmentally compatible. Further preferably, the adhesive and the pesticide are bio-based, i.e. made of renewable resources or renewable raw materials. In variants, the adhesive and/or the pesticide can also be non-biodegradable and/or non-bio-based.

Preferably, the adhesive comprises polylactides (abbreviated to PLA) and/or polybutylene adipate terephthalate (abbreviated to PBAT), preferably a mixture of polylactides and polybutylene adipate terephthalate, in which a proportion of the polylactides is 0% or more than 1% by weight, preferably more than 10% by weight, in particular preferably more than 30% by weight in the adhesive. Thus, a biodegradable adhesive is obtained which, on the one hand, enables the production of a free-flowing semi-finished product and, on the other hand, is inexpensive and easy to use.

Other possible adhesives may include, optionally in addition to one or more of the above adhesives, one or more of the following: Polyamides, polyesters and polycarbonates, polyethers; phenol and amine formaldehydes (such as poly(phenol formaldehyde) resins, poly(melamine formaldehyde) resins, poly(urea formaldehyde) resins and the like); polyimides; polyimines; polysaccharides (such as celluloses, carboxymethyl celluloses, cellulose acetates, cellulose nitrates and the like), polysulphones, polyalkynes. Other representatives of adhesives are known to the skilled person.

Preferably, the pesticide comprises silicon dioxide, especially silica gel, particularly preferably ground silica gel, diatoms, glass powder, glass splinters and/or a boron compound, preferably boric acid. Experiments with diatoms have shown that particularly good durability results can be achieved even with relatively small amounts added. The diatoms can be mined from natural sources or specially cultivated for the application. Further preferably, the pesticide comprises essential oils. For example, the essential oils may comprise lavender oil, rosemary oil, citronella, lemon balm, cedar, peppermint, eucalyptus or sandalwood extract. Preferably, the essential oils are added to the adhesive. In variants or additionally, essential oils can also be added to the semi-finished product or the moulded articles after their manufacture.

Silica gel and boric acid are desiccants that are considered safe by pest controllers. Both substances extract water from the pests, which dries them out. If silica gel or boric acid is eaten by rodents, they dry out from the inside. Eggs of pests or the pests themselves also dry out or are disturbed in their development. This means that the semi-finished product can be protected from a variety of pests.

Furthermore, the use of silica gel has the advantage that it can be used to optimise the coating process, as silica gel can act as a flow improver as a component of the adhesive.

The use of silica gel or boric acid has the advantage that it is largely harmless to humans and is also biodegradable or harmless to nature. However, the expert is also aware of other pesticides that can be used in semi-finished products.

Preferably, the coating comprises at least a first, inner layer and a second, outer layer, wherein the pesticide is in the first, inner layer. Silica gel (and also other pesticides) are hygroscopic. By absorbing water, the silica gel can lose its effect as a pesticide. By providing another layer above the layer containing the pesticide as an adhesive layer and seal, the pesticide can be protected against the absorption of moisture from the environment.

In variants, exactly one layer comprising the pesticide can also be provided.

In principle, the build-up of several layers can also be advantageous if no pesticide is intended. For example, a thicker adhesive layer can be achieved, which is applied particularly evenly. Furthermore, dyes (see below), fragrances and other substances can be added to one or more layers.

Preferably, the first inner layer comprises a mixture of pesticide and adhesive. Even if exactly one layer is provided, this single layer may comprise a mixture of pesticide and adhesive. This technique allows the pesticide to be applied particularly evenly to the foamed biogranulate grains. It is clear to the skilled person that further layers, in particular also an outermost layer, can comprise a pesticide. It is also conceivable, for example, to add a fungicide to the outermost layer, while a rodenticide is provided in an inner layer, possibly together with a fungicide (the skilled person will immediately recognise that other layer structures are also possible). In this way, the layers can take into account the type of pest.

In a process for the production of a semi-finished product, the foamed biogranulate grains are coated with an adhesive and a pesticide.

The coating is preferably applied in at least one first coating drum. In so-called drum coating in the coating drum, the material to be coated is fed into the drum and there, with the drum rotating, the coating material is added, typically sprayed. Different types of coating drums and different operating modes of the coating drums are known to the skilled person, whereby basically all types of coating drums and operating modes can be used for the present coating. In principle, the following steps are preferably carried out:
a. Feeding the foamed biogranulate grains into the first coating drum;
b. Rotating the coating drum;
c. Adding the adhesive and the pesticide.

A large number of tests have shown that the use of the coating drum, in particular a cylindrical coating drum, is particularly advantageous for coating foamed biogranulate grains. However, it is clear to the skilled person that other coating techniques can also be used, for example a spray dryer or the fluidised bed coating process or the like.

Preferably, the first coating drum comprises at least one first lance for applying the coating. The lance is preferably arranged outside the biogranulate grains during the coating process. The lance is thus preferably stationary, arranged in an upper half of the coating drum, i.e. it does not rotate with the rotating coating drum.

In variants, the coating drum can also comprise outlet nozzles or openings for the coating material, which are firmly connected to the drum.

Preferably, the first coating drum comprises a second lance, whereby the adhesive is preferably introduced into the coating drum with the first lance and the pesticide with the second lance.

This means that the entire process can be carried out in a single coating drum. In variants, however, a cascade of coating drums can also be provided, so that in the first coating drum, for example, the first layer with the pesticide is applied and in the second coating drum the second layer, without pesticide, is applied. This has the advantage that the partially coated foamed biogranulate grain can cool down before further coating. Further, the same lance can also be provided sequentially for different products. However, there is a risk that the second layer will be contaminated by the material of the first layer.

In another variant, the coating drum, which comprises two lances, is used to apply adhesive via the first lance in a first step, to apply the pesticide (e.g. as a powder) via the second lance as a second layer and to apply the adhesive via the first lance again as a third layer. In principle, more than three layers can also be provided.

Preferably, the first lance comprises several openings, whereby the adhesive emerges as a liquid jet from the several openings. The openings or nozzles can be circular or elongated, in the form of slits. The number of openings can be between 1 and 50, preferably between 3 and 15. With the multiple openings, a uniform application to the foamed biogranulate grains can be achieved. It has been shown that the application of the adhesive, especially in the case of a polymer liquefied by heating, the application as a liquid jet is of particular advantage, as this prevents the adhesive from cooling down too quickly. When spraying with compressed air, there is a risk that the adhesive will cross-link outside the surface of the foamed biogranulate grains, so that the foamed biogranulate grains are not coated. Under certain circumstances, however, the spraying method with compressed air is nevertheless successful if the temperature of the overall system and the internal air is kept sufficiently high - care must be taken here, however, so that the foamed biogranulate grains are not discoloured or burnt by the heat.

However, it is clear to the person skilled in the art that the adhesive (whether together with the pesticide or not is irrelevant) can also be applied to the foamed biogranulate grains in other ways than as a liquid, for example through nozzles positioned stationary on the drum wall. In principle, however, the foamed biogranulate grains could also be dipped into the liquid adhesive to coat them.

Preferably, the second lance is used to discharge a mixture made of the adhesive and the pesticide. In principle, the two lances can also be used for other multi-layer set-ups.

Preferably, according to the above procedure, within step c. the following steps are carried out in succession:
c1. Application of the pesticide to the foamed biogranulate grains;
c2. Application of the adhesive to the foamed biogranulate grains.

Preferably, the pesticide is mixed with the adhesive in advance so that the pesticide can be applied to the foamed biogranulate grains particularly easily. The adhesive in which the pesticide is applied may be different from the adhesive in step c2. Thus, a first adhesive may be used for the application of the pesticide and a second adhesive may be used for the outer layer which serves to bond the individual foamed biogranulate grains together. The first and second adhesives do not have to be fundamentally different; if necessary, they can only differ in viscosity (e.g. different ratio between PLA and PBAT). On the other hand, different adhesives, which differ in at least one component, can also be used in the different layers.

The pesticide and the adhesive are preferably mixed in an extruder. In this case, the pesticide can be added directly to the foamed biogranulate grains together with the adhesive using the extruder, in particular in a coating drum. In variants, an intermediate product can also be produced with the pesticide and the adhesive, which is heated and introduced as a liquid via nozzles into the coating drum. Further variants are known to the skilled person.

Preferably, after the application of the adhesive (with or without additives), the semi-finished product or the coated, foamed biogranulate grains are cooled so that the coating or the individual layer can harden. Particularly preferably, the cooling process takes place inside the coating drum, with the coating drum rotating. This solidifies the layer or coating, which prevents the foamed biogranulate grains from sticking together. The cooling process can take place after each application of a layer (inner layer, outer layer and, if necessary, further layers). The cooling process can also be omitted.

The cooling process is preferably achieved by blowing in a gas or gas mixture. Dry gas or gas mixture is particularly preferred in order to prevent or reduce sticking and possibly water absorption by the pesticide (e.g. in the case of silica gel or boric acid). The gas is preferably nitrogen, as nitrogen is readily and cheaply available and has hardly any moisture. Air, dried air, CO2 etc. can also be used. The gas can be injected via the lances. The injection can also be carried out via separate nozzles that are firmly connected to the drum or coaxial to the coating drum, e.g. counter-current.

Instead of blowing in gas or a gas mixture, the semi-finished product or the foamed biogranulate grains with one or more layers can also be cooled by a transfer process. This can be done, for example, in a cascade of coating drums during a transfer between the coating drums, in that the foamed biogranulate grains having one or more layers are poured by gravity from the discharge of one coating drum into the feed of the next coating drum. Other possibilities for implementing the cooling process are known to the skilled person.

Preferably, the semi-finished product is used for the production of a moulded body. In this context, a moulded body is understood to be a stable structure, as opposed to a loose bulk material. However, the semi-finished product can also be used as a free-flowing bulk material without forming a moulded body, for example as packaging or insulation material. Further, the shaped body can also be formed only in the application as an insulation or packaging material. For example, the semi-finished product can be filled into a cavity of a wall and then bonded by heating to form a moulded body. This means that the insulation material does not have to be in the form of a plate, which means that no adjustment can be made and thus sections can be avoided. This makes insulation particularly efficient and cost-effective. The semi-finished product can also be filled as packaging material, e.g. into a transport container, which contains a possibly shapeless object, whereby the semi-finished product is subsequently bonded to a moulded body by the action of heat or other activation. Further applications are known to the skilled person.

Preferably, an insulation element for building insulation comprises such a moulded body. In particular, the use of the semi-finished product comprising a pesticide enables the use of the moulded bodies as an insulation element without the risk of the insulation element becoming a victim of pests. This means that foamed biogranulate grains can also be used in construction in the long term. In the event of renovation or demolition of such a building, the insulation element or the moulded bodies can simply be separated and disposed of in the organic waste, since preferably all components of the moulded bodies, i.e. the foamed biogranulate grains, the adhesive and the pesticide are biodegradable.

Preferably, the insulation element comprises at least a first layer and a second layer, wherein the foamed biogranulate grains in the first layer have a smaller average grain size (e.g. according to DIN 18123) than the foamed biogranulate grains in the second layer. This makes it possible to achieve an insulation element with particularly optimal sound insulation. The structure can be achieved in a single manufacturing step by introducing the semi-finished product with different grain size distributions in layers into a mould and finally joining or pressing it under the influence of heat to form the insulation element. In variants, individual insulation elements with different grain size distributions can also be assembled to form such a sound insulation element. The insulation element can have more than two layers with different grain size distributions.

Preferably, the semi-finished product is inserted into a press mould and then joined or pressed into a moulded body under the influence of heat. In some variants, pressing can also be dispensed with. Depending on the adhesive used, other techniques for activating the adhesive can be used instead of heat.

Preferably, the heat effect is achieved by irradiation, in particular with radio wave irradiation. In variants, the heat effect can also be achieved with microwaves, by heating the mould, etc.

In the following, no distinction will be made between the terms moulded body and moulded parts to denote the same thing.

The use of microwaves has the advantage that particularly homogeneous heating is possible, which enables gentle bonding of the moulded parts (moulded bodies). In conventional processes, in which the mould itself is heated, there is the disadvantage that an edge area of the moulded part is heated excessively, which makes it difficult to bake voluminous moulded parts in particular. This disadvantage is particularly relevant when bonding semi-finished products made of foamed biogranulate grains, as the biogranulate grains have a high heat capacity and a low thermal conductivity. These can burn if the heat is too high. By using electromagnetic waves to bake the semi-finished product, the moisture content and the pressure in the moulded part can also be controlled particularly easily. Furthermore, moulded parts with particularly large thicknesses (smallest diameter of the moulded part), in particular with more than 3 cm, preferably more than 5 cm, more preferably more than 8 cm, can be achieved. Furthermore, much larger moulded parts can also be achieved, for example with a smallest diameter of more than 20 cm or more than 100 cm. In addition to the electromagnetic waves, the moulding space with the semi-finished product can, for example, be exposed to hot steam. Furthermore, the moulding chamber can be heated with heating elements. In this case, the electromagnetic waves can only support the heating with heating elements and/or with superheated steam.

It is clear to the expert that the semi-finished product does not necessarily have to contain a pesticide. Depending on how the semi-finished products are stored, the pesticide can be dispensed with. In particular, if the moulded bodies made of the semi-finished product are enclosed in a jacket, for example, a pesticide can also be dispensed with.

In a process for the production of a moulded article, foamed biogranulate grains having an adhesive coating, in particular foamed popcorn with an adhesive coating, are fed into a moulding space of a moulding tool and the foamed biogranulate grains having an adhesive coating are bonded to one another in the moulding space by means of electromagnetic waves.

Preferably, the proportion of foamed biogranulate grains having an adhesive coating is at least 20%, preferably at least 50%, in particular 100%. In variants, the proportion can also be less than 20%. The biogranulate grains may have different compositions, in particular there may be mixtures made of puffed corn and puffed rice or the like. Further, additives such as recycled materials may be added, in particular for example expanded plastics such as for example thermoplastic polystyrene, polypropylene or particle foam parts made of other polymers.

In another variant, the adhesive coating of the biogranulate grains can be dispensed with. In this case, for example, plastic beads can be added to the biogranulate grains and placed in the moulding chamber. By heating the plastic beads, they are melted and connect adjacent biogranulate grains to form clusters. Such a plastic could be, for example, PHBH (polyhydroxybutyric acid and its derivatives). Furthermore, the starch of the biogranulate grains themselves can also be dissolved with water or steam, with which the biogranulate grains can be connected.

Preferably, the mould space is pressurised to a pressure of at least 2 bar, in particular at least 3 bar and preferably at least 5 bar. In variants, the pressure can also be less than 2 bar.

Preferably, biogranulate grains with a moisture content of 4-9 wt. %, in particular with a moisture content of around 7 wt. %, are used. Tests have shown that particularly stable mouldings can be achieved with this. In order to maintain this moisture content, the moulding chamber is preferably pressurised during the process. This prevents the moisture from escaping during heating with the electromagnetic rays. Preferably, the pressure is between 1.5 and 2.5 bar, preferably around 2 bar. The temperature is preferably kept between 100° C. and 140° C., more preferably at around 120° C. The pressure can also be higher than 2 bar. An upper limit of pressure and temperature is around 6 bar and 160° C., since in this range the biogranulate grains oxidise (burn). However, with the addition of a fire retarder or under protective gas, the temperature and pressure range can be increased if necessary. A large number of such flame retardants and protective gases are known to the skilled person.

The overpressure is preferably in the range of 0.1 bar to 10 bar, preferably below 6 bar, particularly preferably between 5 and 7 bar. In variants, the moulded part can also be processed at a negative pressure, in particular at a negative pressure between 0.1 bar and 0.3 bar.

Preferably, the adhesive comprises an organic polymer, an organic copolymer or mixtures thereof, wherein the adhesive is in particular biodegradable and/or bio-based. In variants, other adhesives known to the skilled person can be used.

In particular, thermoplastics, thermosets, aminoplastics, phenoplastics, isocyanates, proteins, tannins, starch, synthetic binders or natural binders, or mixtures of binders can be used as adhesives. Alternatively or additionally, polypropylene, polyethylene, polyvinyl chloride, polystyrene, polyacrylate, polylactic acids (PLA), polyhydroxy acids such as polyhydroxybutyric acid or cellulose derivatives can be used.

Preferably, the proportion of adhesive in the moulding (in % by weight relative to the weight of the moulding) is less than 10%, preferably less than 5%, in particular less than 1%.

Preferably, the adhesive is designed as a hot-melt adhesive and/or as a chemically setting adhesive. This means that either the coating of the foamed biogranulate grains can be melted with the electromagnetic waves or the polymerisation can be initiated with the electromagnetic waves in order to bond the biogranulate grains together.

According to a preferred embodiment, the process is carried out in such a way that when the electromagnetic radiation is used, at least partial bonding and/or melting takes place on the surface of the moulded part.

According to a preferred embodiment, the process is carried out in such a way that when the electromagnetic radiation is used, a temperature of >=70° C. is reached at least in a region on the surface of the moulded part. According to a preferred embodiment of the invention, this can be achieved exclusively by the use of the electromagnetic radiation; according to an alternative embodiment of the invention, additional heating means are provided. These can be, for example, heating elements or also the use of hot steam/hot air or a mixture thereof.

Preferably, the process is carried out in such a way that when using the electromagnetic radiation, a temperature between 60° C. to 160° C., preferably 120° C. to 160° C., is reached at least at one area on the surface of the moulded part. In variants, depending for example on a melting range of the adhesive, the temperature can also be selected to be lower than 100° C., in particular for example lower than 80° C.

According to a preferred embodiment, the electromagnetic radiation has a power of 20 W to 5000 W, still preferably of 50 W to 4000 W, still preferably of 80 W to 3000 W, and most preferably of 100 W to 2500 W. In variants, the power can also be higher than 5000 W, in particular 7000 W or more.

According to a preferred embodiment, the moulding is exposed to electromagnetic radiation such that the power density (measured with respect to the surface of the moulding) is from more than 1 W/cm2 to 250 W/cm2, more preferably more than 2 W/cm2 to 200 W/cm2, more preferably more than 5 W/cm2 to 150 W/cm2 , most preferably more than 10 W/cm2 to 100 W/cm2. The power density can also be more than 250 W/cm2.

According to a preferred embodiment of the invention, the amplitude of the electromagnetic radiation is from 1 kV to 10 kV. In variants, the amplitude can also be greater than 10 kV or less than 1 kV.

According to a preferred embodiment of the invention, radio waves are used during manufacture. This means in particular waves in the frequency range from 30 kHz to 300 MHz. According to a further preferred embodiment of the invention, microwaves are used during manufacture. This means in particular waves in the frequency range from 300 MHz to 300 GHz.

According to a preferred embodiment, the process comprises a pressing step and, during the pressing of the moulded parts, these are temporarily exposed to targeted electromagnetic radiation in a frequency range of 30 kHz to 300 GHz. In particular, a frequency range between 25 MHz and 30 MHz is advantageous.

The electromagnetic waves are further preferably electromagnetic RF radiation. The electromagnetic RF radiation preferably has a frequency of at least 30 kHz or at least 0.1 MHz, in particular at least 1 MHz or at least 2 MHz and preferably at least 10 MHz. In variants, the frequency can also be less than 30 kHz. The frequency can also be much higher than 10 MHz, for example 10 GHz up to 300 GHz or more.

Particularly preferably, the electromagnetic waves are designed in such a way that the adhesive can be melted or polymerisation can be initiated in the adhesive. In variants or additionally, the biogranulate grains are heated with the electromagnetic waves, via which the adhesive is at least partially indirectly heated and thus melted. Preferably, the biogranulate grains have a water content of 6-9% for this purpose. The biogranulate grains can be moistened, preferably with water vapour, before being baked.

Preferably, a substance is added to the binder or the biogranulate grains which converts the radiation into heat more quickly, in particular, for example, common salt or metal particles with particle sizes between 1 nanometre and 100 micrometres, preferably between 5 nanometres and 10 micrometres, particularly preferably between 5 nanometres and 1 micrometre. Furthermore, dyes, in particular dyes with metal ions, can also be used for this purpose. In particular, the process time of bonding can be reduced in the case of moulded bodies with a small thickness, such as plates, cups, cutlery, etc.

The electromagnetic RF radiation particularly preferably has a frequency of 300 MHz or less.

The generator for generating electromagnetic waves preferably generates electromagnetic waves with an amplitude of at least 103 V and, in particular, at least 104 V. However, the amplitude can also be smaller than 103 V.

Commercially available generators produce RF radiation with a frequency of 27.12 MHz. The electromagnetic waves can also be microwaves in the frequency range from 300 MHz to 300 GHz. Furthermore, the electromagnetic waves can also be smaller or larger than the above frequencies.

In the case of semi-finished products which absorb electromagnetic radiation only to a small extent, it is advisable to add a dielectric heat transfer medium, such as water, during welding. Instead, foam particles can also be added to the semi-finished product, which have a better heat transfer. Particularly preferred are materials which have a dipole moment, such as plastics, which have an amide group, urethane group, ester group, etc. However, it is particularly preferred that the adhesive itself has such a dipole moment. Many corresponding plastics are known to the skilled person. Preferably, the technique of compression moulding or automatic moulding machines is used to produce the moulded article.

Preferably, the moulding tool is a crack-split moulding tool. This allows the biogranulate grains to be compressed or pressed in the mould. In variants, other moulding tools can also be used, in particular if expanding substances are added to the semi-finished product.

Preferably, the mould comprises a feeding device via which the mould cavity is filled. In particular, the feeding device is preferably a filling injector operated with compressed air. In variants, the filling can also be carried out by negative pressure. For this purpose, the moulding tool may have one or more connections (e.g. a perforated plate, screen or the like) to evacuate the moulding space. This allows the biogranulate grains to be drawn into the mould cavity via the negative pressure. Furthermore, the filling injector can also be operated with pulsating compressed air, which on the one hand prevents blockages/bridging in the line and on the other hand allows the mould cavity to be filled completely and particularly efficiently (no clumping). In further variants or additionally, the filling injector can also be pressurised with negative pressure on the mould cavity side and pressurised with compressed air on the side of the injector opposite the mould cavity.

The mould preferably comprises a first electrically conductive plate, preferably a metal plate, which may comprise for example steel or aluminium. This plate is preferably connected by a coaxial line to a high frequency generator, whereby RF radiation can be generated. The high frequency generator is connected to an electrical earth. The mould preferably comprises a second electrically conductive plate, which may also be made of steel or aluminium and which is also connected to the electrical earth. The first plate and the second plate are arranged (preferably in parallel) in such a way that they form capacitor plates between which the mould space is located and a high frequency field can be applied. The mould of the moulding tool defining the moulding space is preferably made of a material substantially transparent to RF radiation. This material is for example polytetrafluoroethylene (PTFE), polyethylene, in particular UHMWPE or polyetherketone (PEEK). Alternatively, the mould space may be directly bounded by the two plates. The mould space may include inlet nozzles for supplying liquids, in particular water, water vapour and gases. This allows the heat transfer to be controlled and thus optimised.

The first plate and the second plate form a first and a second condenser element, respectively. The capacitor elements do not necessarily have to be plate-shaped, but can have a three-dimensional design corresponding to the mould space. Kurtz Ersa GmbH has profound knowledge about the calculation of such capacitor elements.

Preferably, the raw density of the moulded part is between 40 and 230 kg/m3. In variants, the raw density can also be lower than 40 kg/m3 or higher than 230 kg/m3.

Other advantageous embodiments and combinations of features come out from the detailed description below and the entirety of the claims.

### BRIEF DESCRIPTION OF THE DRAWINGS

The drawings used to explain the embodiments show:

FIG. 1a a schematic representation of a sectional view of a foamed biogranulate grain with a coating comprising two layers;

FIG. 1b a schematic representation of a sectional view of a foamed biogranulate grain with a coating comprising three layers;

FIG. 2 a schematic representation of a longitudinal section through a coating drum for coating foamed biogranulate grains, with two lances;

FIG. 3 a schematic representation of a longitudinal section through a cascade of a first and a second coating drum for coating foamed biogranulate grains, each comprising a lance;

FIG. 4a a schematic representation of a cross-section through an insulating element with a layer and;

FIG. 4b a schematic representation of a cross-section through an insulation element with two layers. FIG. 2

In the figures, the same components are given the same reference symbols.

### PREFERRED EMBODIMENTS

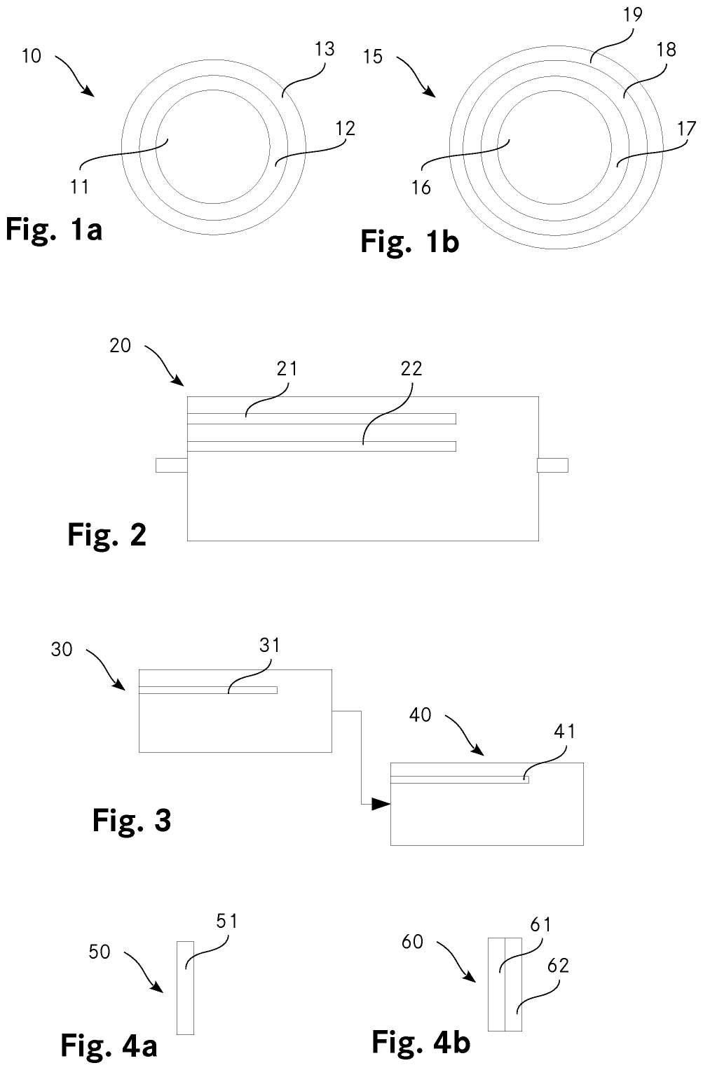

FIG. 1a shows a schematic diagram of a sectional view of a foamed biogranulate grain 11 with a coating comprising two layers, thus forming a semi-finished product 10. In the present case, the foamed biogranulate grain 11 is puffed maize, preferably puffed industrial maize, which is first comminuted (cut into small pieces, preferably 0.7 mm to 4 mm). The grains are then sorted according to size (for example by sieving techniques) and puffed or foamed. A first layer of an adhesive comprising a pesticide is then applied to the foamed biogranulate grain 11. The adhesive is a mixture made of PLA and PBAT (for example Novamont®) and the pesticide is ground silica gel. Both were mixed in an extruder and then applied as a melt to the puffed maize. Furthermore, a tank melter with an agitator can be provided for this purpose, in which Novamont® and the silica gel are mixed and then applied to the puffed maize via a pump. A tank melter can be provided for each of the two coatings. After a cooling process to cool the layer 12, a second coating with the same adhesive is applied to seal the silica gel from the outside air. This prevents the silica gel from absorbing moisture during storage and thus losing its effect. Then it is cooled down again. The cooling takes place via nitrogen supply.

FIG. 1b shows another variant of a semi-finished product 15, essentially analogous to FIG. 1a. The present semi-finished product 15 comprises puffed maize as foamed biogranulate grain 16. The first, inner layer 17 of the semi-finished product 15 is Novamont®, the second, middle layer 18 is silica gel and the outer layer 19, or sealing layer, is Novamont®.

FIG. 2 shows a schematic representation of a longitudinal section through a coating drum 20, for coating foamed biogranulate grains, with two lances 21 and 22. This means that both layers 12 and 13 can be applied to the puffed maize with a single coating drum 20, without having to feed a lance with different products.

FIG. 3 shows a schematic representation of a longitudinal section through a cascade of a first coating drum 30 and a second coating drum 40, for coating foamed biogranulate grains, each comprising a lance 31 and 41 respectively. The puffed maize is coated with the Novamont, which contains silica gel, in the first coating drum 30 by means of the lance 31. The still hot intermediate product is then fed into the second coating drum 40 via a downcomer. The falling strand cools the intermediate product so that no lumps form due to the grains sticking together. Subsequently, a Novamont layer is applied by means of the lance 41 of the second coating drum 40, which forms a sealing layer and enables a long shelf life of the semi-finished product 10.

FIG. 4a shows a schematic representation of a cross-section through an insulating element 50 with a layer 51 made of the semi-finished product 10. For this purpose, the semi-finished product 10 was inserted into a press mould. Due to the choice of adhesive, the semi-finished product 10 is particularly free-flowing, so that the transport of the semi-finished product 10 into the press mould can be automated using conventional means for transporting bulk materials, for example conventional injectors for granulates. Subsequently, the semi-finished product 10 is subjected to radio waves under pressure so that the adhesive of the individual grains bonds and forms a moulded body. The insulation element 50 can be used for building insulation, as a packaging material (shock absorber), furniture construction, etc.

FIG. 4b shows a schematic representation of a cross-section through an insulation element 60 with two layers 61 and 62. The two layers 61 and 62 differ in grain size distribution. This makes it possible to achieve particularly effective sound insulation. The insulation element 60 can be manufactured in the same way as the insulation element 50. In particular, the multiple layers can be achieved in a single manufacturing step by successively feeding semi-finished product 10 with different grain sizes into the mould and then bonding the whole thing under heating. Alternatively, several insulation panels with different grain sizes can be bonded together to form a single insulation element 60.

In summary, it can be stated that according to the invention a semi-finished product is created which is characterised by good durability and optimal flowability. Furthermore, a particularly efficient manufacturing process is provided for the semi-finished product and, finally, a particularly dimensionally stable moulded body is achieved, which is also characterised by very good durability due to the pesticide additives.

1. A semi-finished product for the production of a moulding, comprising foamed biogranulate grains having a coating comprising an adhesive configured such that the biogranulate grains can be bonded to one another in the moulding.

2. The semi-finished product according to claim 1, wherein the adhesive comprises at least one of polylactides, polybutylene adipate terephthalate, and a mixture of polylactides and polybutylene adipate terephthalate; in which a proportion of the polylactides is 0% or more than 1% by weight, or more than 10% by weight, or more than 30% by weight in the adhesive.

3. The semi-finished product according to claim 1, wherein the pesticide comprises at least one of silica, silica gel, diatoms, glass powder, glass splinters, ground silica gel and/or a boron compound, and boric acid and/or essential oils comprising one or more of lavender oil, rosemary oil, citronella, lemon balm, cedar, peppermint, eucalyptus and sandalwood extract.

4. The semi-finished product according to claim 1, wherein the coating comprises at least a first, inner layer and a second, outer layer, such that the pesticide is arranged in the first, inner layer.

5. The semi-finished product according to claim 4, wherein the first, inner layer comprises a mixture of pesticide and adhesive.

6. A method for producing a semi-finished product, comprising the steps of:
coating foamed biogranulate grains with a coating comprising an adhesive configured such that the biogranulate grains can be bonded to one another in a molding, and
wherein the coating comprises a pesticide.

7. The method according to claim 6, further comprising the steps of:
applying the coating in at least one first coating drum;
introducing the foamed biogranulate grains into the first coating drum;
rotating the first coating drum; and
introducing the adhesive and the pesticide.

8. The method according to claim 7, wherein the first coating drum comprises at least one first lance configured to apply the coating outside the biogranulate grains during coating.

9. The method according to claim 7, wherein the first coating drum comprises a second lance and wherein the method further comprises the steps of introducing into the coating drum with the first lance the adhesive and with the second lance the pesticide.

10. The method according to claim 7, wherein the first lance comprises a plurality of openings, arranged and configured such that the adhesive emerges as a liquid jet from the plurality of openings.

11. The method according to claim 9, further comprising the steps of:
forming a mixture of the adhesive and the pesticide; and
discharging the mixture with the second lance.

12. The method according to claim 7, wherein the step of introducing the adhesive and the pesticide further comprises the steps of:
1. applying the pesticide to the foamed biogranulate grains; and
2. applying the adhesive to the foamed biogranulate grains.

13. (canceled)

14. (canceled)

15. (canceled)

16. A method for producing a moulded body comprising the steps of:
coating foamed biogranulate grains with a coating comprising an adhesive configured such that the biogranulate grains can be bonded to one another in moulding, wherein the coating comprises a pesticide to obtain a semi-finished product;
introducing the semi-finished product into a press mould; and
joining the semi-finished product under the action of heat to form the moulded body.

17. The method according to claim 16, wherein the action of the heat is effected by irradiation, and a radio wave irradiation.

18. (canceled)

19. The method according to claim 16, wherein a proportion of foamed biogranulate grains having an adhesive coating comprises at least 20%, at least 50%, or 100%.

20. The method according to claim 16, further comprising the steps of pressurizing the moulding chamber with a pressure of at least 2 bar, at least 3 bar or at least 5 bar.

21. The method according to claim 16, wherein the adhesive comprises at least one of an organic polymer, an organic copolymer, a mixture of organic polymer and organic copolymer, and wherein the adhesive is biodegradable and/or biobased.

22. The method according to claim 16, wherein the adhesive comprises a hot-melt adhesive and/or a chemically setting adhesive.

23. The method according to claim 16, further comprising the steps of adding at least one of a heat transfer medium, a liquid, and water to the foamed biogranulate grains having an adhesive coating during welding by means of electromagnetic waves.

24. (canceled)

25. (canceled)

26. (canceled)

27. (canceled)
